(19) United States
(12) Patent Application Publication
(10) Pub. No.: US 2016/0247411 A1
(43) Pub. Date: Aug. 25, 2016

(54) SYSTEM AND METHOD FOR LEARNING

(71) Applicant: ABDO SHABAH MD INC., Montréal (CA)

(72) Inventor: Abdo Shabah, Montréal (CA)

(21) Appl. No.: 15/029,713

(22) PCT Filed: Oct. 16, 2014
(86) PCT No.: PCT/CA2014/050999

§ 371 Date: Apr. 15, 2016

Related U.S. Application Data
(60) Provisional application No. 61/891,591, filed on Oct. 16, 2013.

(51) Int. Cl. G09B 7/06; G09B 19/00

(52) U.S. Cl. CPC G09B 7/06; G09B 19/00

(57) ABSTRACT

The present invention relates to the field of interactive learning. More particularly, the present invention relates to a method for learning, directed to a learner of a professional practice, and to a processor-readible storage comprising data and instructions for carrying out the method, as well as to a corresponding system for learning. Questions relative to the professional practice are stored in association with respective answers. Based on professional activity information being representative of an activity performed by the learner in the context of the professional practice, a client device is triggered to present a selected question to a learner. A response is received from the learner and processed.

### FIELD OF THE INVENTION

The present invention relates to the field of interactive learning. More particularly, the present invention relates to a method for learning, directed to a learner of a professional practice, and to a processor-readible storage comprising data and instructions for carrying out the method, as well as to a corresponding system for learning.

### BACKGROUND OF THE INVENTION

There is a need for professionals of given fields of practice to continuously develop and share their expertise. Health informatics deals with the resources, devices, and methods required in order to optimize the acquisition, storage, retrieval, and use of information in health and biomedicine.

Known in the art are script concordance tests as described in an article of BioMed Central entitled “Script Concordance Tests: Guidelines for Construction” (by Jean Paul FOURNIER et al.) published on May 6, 2008.

Also known to the Applicant is an article entitled “A reference model for mobile social software for learning” (by Tim DE JONG et al.) published in Int. J. Cont. Engineering Education and Lifelong Learning, Vol. 18, No. 1, 2008, pages 118 to 138.

Also known to the Applicant is an article entitled “The Practicum Script Concordance Test: An Online Continuing Professional Development Format to Foster Reflection on Clinical Practice” (by Eduardo H. HORNOS, MD et al.) published in Journal of Continuing Education in the Health Professions, 33(1):59-66, 2013.

Also known to the Applicant is an article entitled “Le test de concordance comme outil d'évalutation en ligne du raisonnement des professionels en situation d′incertitude” (by Bernard CHARLIN et al.) published in Revue international des technologies en pèdagogie universitaire, at pages 22 to 27 (www.profetic.org/revue), in 2005.

Also known to the Applicant is an article entitled “Online clinical reasoning assessment with the Script Concordance tests: a feasibility study” (by Louis SIBERT et al.) published in BioMed Central on Jun. 20 2005.

Also known to the Applicant is an article entitled “Online Script Concordance Test for Clinical Reasoning Assessment in Otorhinolaryngology” (by Romain E. KANIA, MD, et al.) published at www.archoto.com at University of South Caroline, on Aug. 23, 2011.

Also known to the Applicant is an article entitled “Creation of self-assessment tools for on-line continuing medical education. Modelization of a training session” (by Michel KALAMARIDES et al.) published in ScienceDirect, Neurochirurgie 54 (2008), 21-27.

Also known to the Applicant is an article entitled “L'évaluation du raisonnement clinique” (by Bernard CHARLIN et al.) published in Pédagogie Médicale—Février 2003-Vol. 4-No. 1, in February 2003.

Also known to the Applicant are U.S. Pat. No. 5,991,595 A, No. 6,773,266 B1, No. 8,195,498 B2, and No. 8,412,661; United States patent applications published under No. 2012/0156664 A1, No. 2012/0225239 A1, No. 2012/0245952 A1, No. 2013/0141959 A1, No. 2013/0149682 A1, No. 2013/0288220 A1, No. 2013/0302772 A1, No. 2014/0057241 A1, No. 2014/0072948 A1; and the International Patent Application published under No. WO 2014/040179 A1.

However, there is a need for a better management of knowledge and learning which better follows individual performances, adapts to the personal needs of individuals in professional fields and/or which cooperates better with the actions and context of the professionals in their practice.

Hence, in light of the aforementioned, there is a need for an improved system which, by virtue of its design and components, would be able to overcome some of the above-discussed prior art concerns.

### SUMMARY OF THE INVENTION

An object of the present invention is to provide a learning system and associated method for learning in a field of professional practice.

In accordance with an aspect, there is provided a method for learning, directed to a learner of a professional practice. The method comprises: storing, in a storage, questions and associated answers, relative to the professional practice;

receiving, via an input port, professional activity information being representative of an activity performed by the learner in the context of the professional practice; by means of a triggering device, triggering a client device to present a selected one of said questions to the learner based on the professional activity information; in response to said triggering, presenting the selected question on the client device, by means of a question presentation module, in accordance with the activity performed; and processing by means of a processor, a response received from the learner on the client device.

According to an embodiment, the method further comprises building at least one of said questions and associated answer(s). The question may be built according to a structure format of the question, for example in accordance with a Script Concordance Test (SCT) format. The building of the question may comprise receiving input information from a plurality of experts, via a user interface of respective client devices for example, and processing the input information, for example at a central server, in order to build the question collaboratively. The building process may further comprise prompting a user (which may be an expert for example, or even learner) to enter input information and processing the input information according to a predetermined process to generate the question.

Thus, in a particular embodiment, a user may submit a tentative question or information to be transformed into a question for the present learning method, as a first step. In one or more subsequent steps, this input information may be processed via a workflow. The workflow may allow formatting the input information into a desired question and answer format. Alternatively or additionally, the workflow may be adapted to process the question through a submission process, a modification process, a validation process and/or an approval process. Alternatively or additionally, the workflow may be designed to allow a plurality of users to access one or more of the submission, modification, validation and approval processes. Each of the submission, modification, validation and approval processes may further be restricted to specifically authorized users, either based on their particular identity or based on their profile. For example, the approval process may be restricted to a particular individual or group of individuals, while the submission process may be open to a broader community of users. In addition, the modification and validation process may be limited to users having a profile indicating a particular expertise in the knowledge category of a particular question being built.

According to an embodiment, a list of questions may be built in accordance with an automated process. In a particular embodiment, the building of questions comprises: providing, in a storage, a question template comprising one or more base question-element and one or more variable question-element, each variable question-element being associated to a plurality of possible values; and generating, by means of a processor, a list of question instances, each instance comprising a unique combination of one of said possible value for each variable question-element within the question template. Thus, for a given template, a multitude of questions may be quickly generated without requiring the manual entry of information. In an alternative embodiment, a question instance is generated on an on-demand basis in conjunction with the question presentation step, to generate a question dynamically based on the stored template and possible values for each variable. Indeed, in one example, the possible value is chosen based on the professional activity information, such that the question instance is aligned with the activity performed by the learner. It is to be understood that in some cases the choice of possible values is not affected by the professional activity information.

It is to be understood that the possible values for the variable question-element(s) of a question template are chosen to be compatible with all or most of the possible combinations thereof. In some case, a possible value of one variable is associated with a possible value of another variable, in that they must be combined together in a given question instance, in order for the question to make sense. Thus, the generating step may further comprise taking into account such limiting conditions. In a particular embodiment, the question instances generated are further submitted to one or more user for review. The review process may include: presenting each of the question instances having been generated to the reviewer for validation, modification, deletion, approval, filtering and/or resubmitting as a new question. In some embodiments, only question instances having flagged by the processor as having a warning, are submitted for review.

For example, the method may include a processor-implemented logic to validate each question according to predetermined validation conditions, and to flag a warning to a question instance when a validation condition is unsatisfied.

According to an embodiment, the triggering step is based on a time information. For example, the triggering may be set to occur at a given date and time. In a particular embodiment, the time information comprises a recurrence setting in order to recurrently present a new one of said questions. For example, a new question may be presented each day, at a particular time, or within a particular time period. The time of presentation of the question may be further combined with other information or conditions, as can be understood by the skilled person in the art.

In some embodiments, the presenting of a question and associated processing step are sequentially repeated upon said triggering, in order to process a set among the stored questions. In some embodiments, the sequential repeating is limited within a time period.

Indeed, the recurrence setting, date and time information, or overall triggering or presenting step may be limited to other conditions. For example, the method may be adapted to: present questions during workdays only; once a time condition is met, to further wait for a location condition to be met before presenting a question to the learner; and/or to avoid presenting a question in a particular location; etc.

According to an embodiment, the triggering occurs based on location information associated to the learner. More particularly, one or more reference location is stored in a memory, and the triggering comprises: receiving the location information in a processor; comparing, by means of the processor, the location information received with the reference location; and upon identifying a match between the location information and the reference location, triggering the question presentation module to present the question. The location information may be received by means of at least one among: a geo-location sensor; a proximity sensor; and information entered in an electronic filing system. A geo-location sensor or device may be located on a portable device associated to the learner. A proximity sensor may be located in a fixed location to cooperate with a portable device being communicatively operable with the proximity sensor to indicate that the portable device is in a particular location corresponding to the fixed proximity sensor.

Alternatively, the location information may be based on a predetermined schedule stored in a memory. For example, based on a time of day, the system may correlate a time slot associated with the learner to a particular location of the learner. In some cases, a time delay is given prior to triggering a question, when it is unlikely that the learner will be able to process the question during a particular operation or activity, but more like to process it after or even before the activity.

According to some embodiments, knowledge categories of the professional practice are provided, and each question is associated to a particular knowledge category (or more to knowledge categories). The location information is also associated to one or more knowledge category(ies), in this embodiment. In the presenting step, the question to be presented is then selected to correspond to the knowledge category of the location information.

Thus, the triggering may further require other condition(s), such as leaving a particular room or location, waiting for a time delay, matching schedule information, etc.

According to other embodiments, a target knowledge category is received, either based on the location information or other information, and the question is selected based on this target knowledge category. Indeed, the target knowledge category may be based on time information. For example, the time information may be indicative of a knowledge category based on the activity to be performed within a predetermined schedule.

In other embodiments, the knowledge category is received based on information entered in an electronic filing system being indicative of activity in a particular area of practice. Alternatively, the knowledge category may be received based on profile information associated to the learner. The profile information may include: an area of expertise of the learner; past experienced cases of a learner within the professional practice recorded in memory, where each case is associated to one or more knowledge category; an area of interest for the learner associated to one or more knowledge category; and a schedule of the learner wherein different timeslots are each associated to one or more knowledge category.

In accordance with another aspect, there is provided a processor-readable storage medium for learning, the processor-readable storage comprising data and instructions for execution by a processor, to execute steps of the above-described method. According to embodiments, the processor-readable storage medium is a non-transitory storage device.

In accordance with another aspect, there is provided a system for learning, directed to a learner of a professional practice. The system comprises: a storage for storing questions and associated answers, relative to the professional practice; an input port for receiving professional activity information being representative of an activity performed by the learner in the context of the professional practice; a triggering device comprising said input port, for triggering a client device to present a selected one of said questions to the learner based on the professional activity information; a question presentation module being in communication with the storage and the triggering device, for presenting the question on the client device, in response to said triggering according to the activity performed; and a processor for processing a response received from the learner through the client device. The processor may be provided on a server which communicates with the client device over a communication network.

In some embodiments, the system further includes a question building module being in communication with the storage, for building at least one of said questions and the associated answers to each question.

In some embodiments, the triggering device communicates with or comprises a clock. In some embodiments, the triggering device communicates with or comprises at least one of: a position sensor, a geo-location sensor, a proximity sensor, an electronic filing system.

In the context of the present description, the term “processor” refers to an electronic circuitry that can execute computer instructions, such as a central processing unit (CPU), a microprocessor, a controller, and/or the like. A plurality of such processors may be provided, according to embodiments of the present invention, as can be understood by a person skilled in the art. The processor may be provided within one or more general purpose computer, for example, and/or any other suitable computing device.

Still in the context of the present description, the term “storage” refers to any computer data storage device or assembly of such devices including, for example: a temporary storage unit such as a random-access memory (RAM) or dynamic RAM; a permanent storage such as a hard disk; an optical storage device, such as a CD or DVD (rewritable or write once/read only); a flash memory; and/or the like. A plurality of such storage devices may be provided, as can be understood by a person skilled in the art.

The objects, advantages and features of the present invention will become more apparent upon reading of the following non-restrictive description of preferred embodiments thereof, given for the purpose of exemplification only, with reference to the accompanying drawings.

### BRIEF DESCRIPTION OF THE DRAWINGS

FIG. 1 is a schematic representation of the collaborative learning system, according to an embodiment of the present invention.

### DETAILED DESCRIPTION OF PREFERRED EMBODIMENTS OF THE INVENTION:

In the following description, the same numerical references refer to similar elements. The embodiments mentioned and/or geometrical configurations and dimensions shown in the figures or described in the present description are embodiments of the present invention only, given for exemplification purposes only.

Broadly described, the learning system according to a preferred embodiment of the present invention, as exemplified in the accompanying drawings, provides a collaborative platform for assessing and sharing knowledge in a field of professional practice.

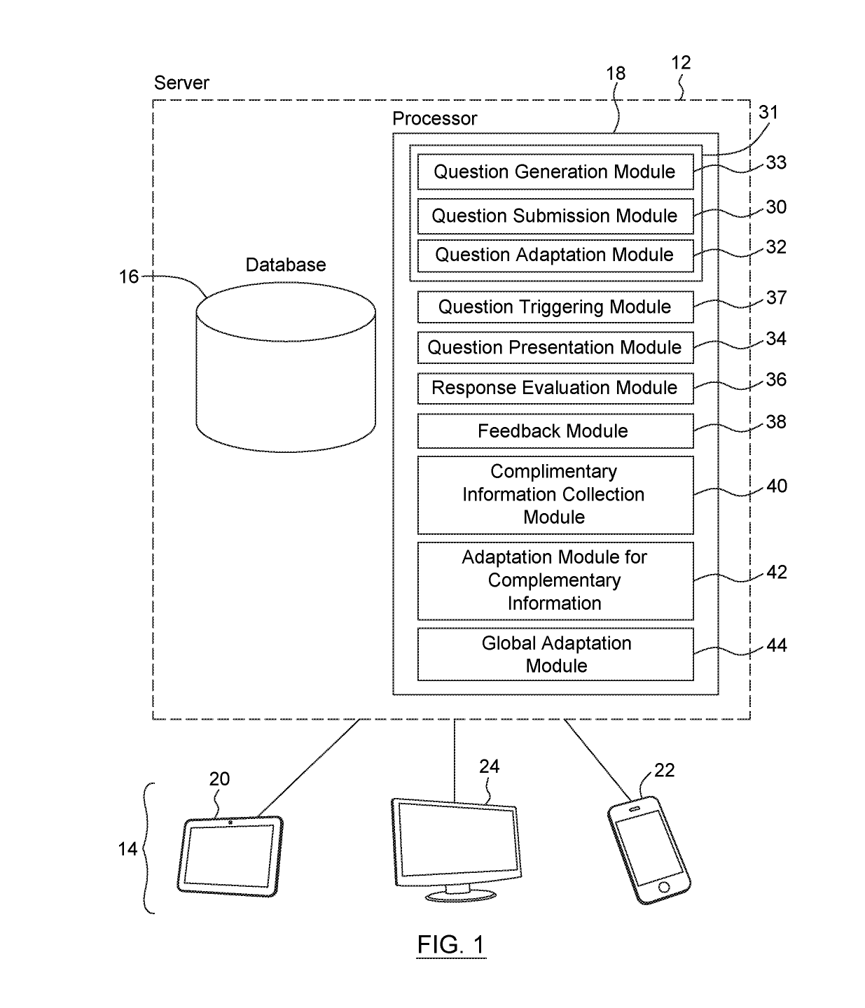

Thus, as better illustrated in FIG. 1, there is provided a learning system 10, according to a particular embodiment, comprising a server 12 being in communication with a plurality of client devices 14. The server 12 comprises a database 16 and a processor 18 communicating with the database 16. The database 16 stores questions relative to health practice and associated answers, as well as other associated information as will be explained further below. The questions and answers may relate to one or more particular field of medicine or health practice and are provided by a panel of reference experts in the particular field.

The server 12 may be provided by a general purpose computer, or the like. It is to be understood that the server may be provided by a plurality of such general purpose computers being in communication with each other so as to cooperate for providing the services. Typically, the server includes software, located centrally or distributed, and adapted for providing necessary services to the client device, as will be better described herein. With reference to FIG. 1, the client device 14 is preferably a portable computer device such as a tablet computer 20, a mobile phone or smart phone 22, a laptop, or the like. Alternatively, the device may be a desktop computer 24 or similar device.

Preferably, the database 16 is provided centrally in a central server. Alternatively, the database 16 include one or more databases which may be located on one or more servers 12, as can be understood by a person skilled in the art.

Question Format

The questions are presented on one of the client devices 14 to be answered by an “examinee”, i.e. a person who is examined. The questions are case-based, describing a scenario and providing a diagnosis hypothesis (a series of hypotheses may be provided for the examinee to choose from). In a second part of the question, a new clinical finding information is presented to the examinee, depending on the chosen diagnosis hypothesis. Based on this new information, the examinee must enter a ranking as to the effect of this new information on the initial hypothesis. This response is chosen by the examinee from five options of a Likert scale ranging from −2 to +2, where −2 indicates an important reversal of the initial hypothesis, −1 indicates a mild reversal, +2 indicates an important confirmation of the initial hypothesis, +1 indicates a mild confirmation and 0 indicates no effect on the initial hypothesis.

Users, Accounts and User Profiles

A user interacts with the system via a user account. Users have different levels of expertise in the field of medical practice and are thus associated to user profiles, for example: “novice”, “practitioner”, “expert”, “super expert”. A secure logon process is embedded to allow each user to access the system and interact with the system in a personalized manner. It is to be understood that user profiles dictate the privilege level of a user for various functional modules of the system.

A user may be an expert in a particular field of medicine. Also a same user may be an expert in one field and a novice in other fields of medicine.

Construction of Questions

According to a preferred embodiment of the present invention, questions are built and/or approved collaboratively via a ‘question submission module’ 30 and a ‘question adaptation module’ 32, integrated in the processor of the server. The question submission module 30 and question adaptation module 32 are part of a ‘question building module’ 31.

The question submission module 30 may receive a draft question from a user of the system 10, via a client device 14. The system 10 preferably provides user interface features for the client device 14, to standardize the input information for building the question. The question may be submitted for example, via a workflow and/or a form, guiding the user to enter the necessary information in a desired format. For example, the user may be guided to enter a particular field of medicine the question relates to, as well as to format the questions to provide a scenario, a diagnosis hypothesis and a new finding as mentioned above, and to limit the question to a particular number of words.

The user may also be presented with examples of other questions.

It is to be understood that the workflow may be adapted based on the user profile (whether novice, practitioner, expert, etc.), which in turn may be adapted based on the field of practice associated to the question.

It is to be understood that the system 10 receives such draft questions from a plurality of users or groups of users, i.e. crowdsourcing, to build a pool of questions. The question may be provided with an associated correct answer, with a tentative answer or without an answer.

Thus, a learner (i.e. “examinee”) may input his/her own particular scenario in a question format for approval/reviewing by a panel of experts, or of other users. The expert's responses may then provide the learner with the information he/she needed, as well as to further populate the question base in the database 16.

The draft question received by the question submission module may be evaluated based on predefined criteria and approved for submission to the community of examinees (via a validation module integrated in the processor, and/or via the client devices by one or more users selected to validate submitted questions). Alternatively, when the draft question requires refining, the draft is transferred to a ‘question adaptation module’ 32.

This module 32 generally receives draft questions which require refining before being submitted to the community of examinees. The draft questions are queued for processing by a selected group of users (which may include experts to validate the content, and/or other users to adapt the format, etc.). Thus, the question adaptation module 32 allows for modifying the content of the question and/or associated answer, completing the question with an answer, standardizing the format of the question and/or the like, in a collaborative approach. The question adaptation module 32 may further allow merging similar draft questions submitted by different users, into one question.

The question adaptation module 32 thereby provides a structured crowdsourcing approach to building the pool of formatted questions and answers.

The module 32 produces a completed and approved version of the question.

According to an embodiment, a list of questions may be built in accordance with an automated process, by means of a Question Generation Module 33, as depicted in FIG. 1. A question template is provided from which a plurality of question may be derived. More particularly, each question template comprises base question-element(s) and variable question-element(s), each variable question-element being associated to a plurality of possible values. The Question Generation Module 33 then generates a list of question instances, each instance comprising a unique combination of one of the possible values for each variable question-element within the question template. Thus, for a given template, a multitude of questions may be quickly generated without requiring the manual entry of information.

In an alternative embodiment, a question instance is generated on an on-demand basis in conjunction with the question presentation step, to generate a question dynamically based on the stored templates and possible values for each variable in each template. Indeed, in one example, the possible value is chosen based on the professional activity information, such that the question instance is aligned with the activity performed by the learner. It is to be understood that in some cases the choice of possible values is not affected by the professional activity information.

It is to be understood that the possible values for the variable question-element(s) of a question template are chosen to be compatible with all or most of the possible combinations thereof. In some case, a possible value of one variable is associated with a possible value of another variable, in that they must be combined together in a given question instance, in order for the question to make sense. Thus, the generating step may further comprise taking into account such limiting conditions. In a particular embodiment, the question instances generated are further submitted to one or more user for review. The review process may include: presenting each of the question instances having been generated to the reviewer for validation, modification, deletion, approval, filtering and/or resubmitting as a new question. For example, a process based on an interactive genetic algorithm may be provided to refine the pool of dynamically generated questions. In some embodiments, only question instances having been flagged by the processor as having a warning, are submitted for review. For example, the method may include a processor-implemented logic to validate each question according to predetermined validation conditions, and to flag a warning to a question instance when a validation condition is unsatisfied.

In some embodiments, the review process may include submitting the question to a community of users (which may include experts and/or learners), and receiving from the users, appreciation information relative to the question submitted. This appreciation information is then processed to upvote or downvote the question, filter out a question, resubmit a question for refining, etc. The appreciation information may relate to the quality of the question, the relevance of the question, the accuracy of the information contained in the question and the answer, and/or the like. This crowd sourcing process may be applied to questions having been processor-generated, as well as to questions entered by users.

Presenting of Questions

Once a question is approved, it is stored within the database 16 in pool of questions ready for presentation to examinees, who may also be referred to as “learners” of the professional practice. More particularly, a ‘question presentation module’ 34, integrated in the processor 12, sends the questions for presentation on a client device 14 of a learner.

The presentation of a question may be initiated based on numerous triggers.

According to one option, a question or a series of questions may be submitted periodically based on time only (for example, 5 questions may be queued every day of the week), allowing the end user, i.e. the “examinee” to answer the questions whenever it is suitable to him or her.

According to another option, the location of the client device is monitored and upon detecting a particular location and/or date/time, an examinee is prompted in real-time, via the client device with one or more question related to a field associated with the particular location. For example upon entering an oncology room, the question presentation module is triggered to present one or more question related to cancer treatment. In this scenario, the client device is preferably a portable device which generally follows the examinee.

According to another option, the system communicates with an electronic medical record (EMR) system or medical billing system, for example, and triggers one or more question related to a particular field based on patient health information entered in the EMR or billing system. It is to be understood that the system may communicate with any other suitable database or information system, instead of or in addition to the EMR and/or billing system.

It is to be understood that the above triggers may be combined (using conditions and prioritizing triggers, for example), as may be readily understood by a person skilled in the art.

The context information may also be taken into consideration to trigger questions “during an action”, i.e. in real-time upon entering a room or immediately after entering health information, or “post-action”. Context information may include location (obtained from sensing device or global position system (GPS)), and EMR or billing input, etc. Examples of “post-action” situations include after leaving a room, after a predetermined time-delay following the entering/exiting of a room, following an operation entered in the system, following the entry of patient health information in the EMR or billing system, etc. For example, in the case of an emergency operating room, it may not be suitable to submit questions to the healthcare professional during the action. “Post-action” may also refer to predetermined time-delay following an acquired concept or pedagogical learning experience, to provide information recall and reinforce a knowledge base of the learner.

Response Evaluation Module

A ‘response evaluation module’ 36 (which may be integrated in the processor of the server and/or in a processor of the client device, via a corresponding client application), is adapted to receive the examinee's response to the question from the client device and to calculate a score by comparing the response received with the answer associated to the question. The score may be output on the client device 14.

The answer is predetermined based on the answers obtained to the same question from the panel of reference experts. For example, if 8 out of 10 experts answered “−1”, then the stored answer would be “−1”. And the deviation between the examinee's answer (either −2, −1, 0, 1 or 2) and the correct answer (“−1”) determines the score. The closer the examinee's answer is to the correct answer, the higher the score. It is to be understood that answer scale may be broader, depending on particular embodiments, or that other suitable answering systems may be used.

The results obtained from an examinee's responses to questions are also stored in the database 16 in association with the particular examinee.

An examinee who consistently scores highly for questions in a particular field of medicine, may eventually be marked in the database as an expert in relation to that particular field, based on a processing of the scores associated to the examinee.

It is to be understood, that according to some embodiments, experts may have a ranking, so as to give more weight to answers provided by some experts over others.

Thus, crowdsourcing is also incorporated in the determination of the answer to a submitted question.

Feedback Module

A ‘feedback module’ 38, also integrated in the processor 18, produces a feedback operation based on the score of a responder.

As previously mentioned, the feedback module receives the score calculated by the response evaluation module, and produces one or more feedback operation based on the score.

Examples of feedback operation include:
storing or updating the score of the examinee in the database;
returning a new question to the client device based on the first question and the score;
providing complementary information for output on the client device, in relation to the scenario of the question having been submitted, where the complementary information provided may depend on the score; and
determining and storing in the database in association with the examinee, an expertise level based on the score.

The choice of question presented to a user or group of users may be made in association with the feedback module 38. Namely, the feedback module takes into account information previously populated in the database via previous questions asked, i.e. previous scoring for questions of a particular field and/or previous experiences, in order to select the particular question. It is to be understood also, that other contextual elements (location and timing) may be taken into account.

It is to be understood that this module 38 or a portion thereof may be located and/or operated at the client device(s) 14.

Complementary Information Collection Module

After an examinee responds to a question, a ‘complementary information collection module’ 40, integrated in the processor 18, may prompt the examinee, via the client device 14, to enter reference information supporting his or her answer. This information may be requested systematically after each question is answered or it may be requested sporadically (based on a random selection and/or when particular criteria are met, such as when an answer corresponding to an unexpected score based on the level of expertise of the examinee, when the level of confidence of an answer is relatively low, when a question raises a high level of interest to the community of users and/or the like).

The examinee is prompted to enter reference information (a link to a website, a video, etc.) or a text justification. This information entry may be optional, according to some embodiments.

It is to be understood that this module 40 or a portion thereof may be located and/or operated at the client device(s) 14.

Adaptation Module for Complementary Information

Moreover, an ‘adaptation module for complementary information’ 42, integrated in the processor 18, prompts the examinee to enter this complementary information according to a workflow, based on a structured approach. Furthermore, the type of information requested from the examinee may be adapted by the adaptation module based on the level of expertise of the user in relation to the field of the question.

It is to be understood that this module 42 or a portion thereof may be located and/or operated at the client device(s) 14.

Global Adaptation Module

A ‘global adaptation module’ 44 allows adapting the pool of questions according to user responses to reflect pertinence, difficulty level, etc. For example, when a question has been subjected to a large group of users and that the response has been answered very uniformly for a period of time, it may not be useful to present this question in the future. Moreover, when a question concerns a topic which is no longer relevant, the question should be removed from the pool of questions. Another example, is when an answer to a question requires updating, the answer must be updated for future presentation to examinees. The global adaptation module 44 may process the conditions automatically and perform a “clean-up” or the like and/or it may output to a selected community of users a series of questions to be reviewed, the questions being selected based on particular conditions. Another use of the Global Adaptation Module is to generate a specific set of questions to all users or specific database users for “mass assessment” of a particular expertise in the specified sample of practitioners or learners. This use could be applied in public health emergencies, or through a guideline revision, in any medical context requiring an assessment of level of knowledge of a sample, or the full population of learners and practitioners.

Thus worded differently, in accordance with an embodiment and with reference to FIG. 1, there is provided a method for learning, directed to a learner of a professional practice, where the method comprises: storing questions and associated answers in a storage (such as database 16), relative to the professional practice; receiving, via an input port, professional activity information being representative of an activity performed by the learner in the context of the professional practice; by means of a triggering device (which may cooperate with a question triggering module 37), triggering a client device to present a selected one of said questions to the learner based on the professional activity information; in response to said triggering, presenting the selected question on the client device (for example 20, 22 or 24), by means of a question presentation module (for example, 34), in accordance with the activity performed; and processing by means of a processor (for example, the processor 18), a response received from the learner on the client device (by means of any one or more among: the response evaluation module 36, the feedback module 38, the complimentary information collection 40, the adaptation module 42, and the global adaptation module 44, embedded in the processor 18).

In accordance with another optional aspect, there is provided a collaborative learning system comprising: a question construction module, integrated in a processor, for constructing a question to be submitted to a examinees of a professional practice, said question construction module being in communication with a plurality of client devices in order to collaboratively construct the question; and a storage for storing the constructed question and for presenting said question on a user interface.

In accordance with another optional aspect, there is provided a collaborative learning system comprising: a database for storing questions relative to a professional practice and associated answers; a question presentation module, integrated in a processor and in communication with the database to present a question to a client device associated to a user who is an examinee of said professional practice; a response evaluation module, integrated in the processor, adapted to receive a response to the question from the client device and to calculate a score for the examinee by comparing the response received with the answer associated to the question in the database; a feedback module, integrated in the processor, for producing a feedback operation based on the score. Preferably, the feedback operation includes at least one of: storing or updating the score of the examinee in the database; returning a new question to the client device based on the first question and the score; and providing complementary information in relation to the question having been submitted; and determining and storing in the database in association with the examinee, an expertise level based on the score.

In accordance with yet another optional aspect, there is provided a method, comprising the steps of: providing in a database, questions relative to a professional practice and associated answers; presenting one of said questions for display on a client device of an examinee of said professional practice; receiving a response to the question from the client device and calculating a score for the examinee by comparing the response received with the answer associated to the question in the database; and producing a feedback operation, preferably on the client device, based on the calculated score.

Embodiments of the present invention are advantageous in that health professionals may continuously develop their knowledge in relevant fields, and that the knowledge is shared. In addition, users (experts and learners) collaborate to populate the question database, as well as to achieve a consensus on the answers to the questions.

Embodiments of the present invention are further advantageous in that they utilize crowdsourcing for various features of the system, in order to provide a collaborative learning platform.

Furthermore, although the above described embodiments are directed to the field of health and medicine, it should be understood, that the present invention may also be applied to any other suitable evolving fields of professional practices.

The above-described embodiments are considered in all respect only as illustrative and not restrictive, and the present application is intended to cover any adaptations or variations thereof, as apparent to a person skilled in the art. Of course, numerous other modifications could be made to the above-described embodiments without departing from the scope of the invention, as apparent to a person skilled in the art.

1. A method for learning, directed to a learner of a professional practice, comprising:
storing, in a storage, questions and associated answers, relative to the professional practice;
receiving, via an input port, professional activity information being representative of an activity performed by the learner in the context of the professional practice;
by means of a triggering device, triggering a client device to present a selected one of said questions to the learner based on the professional activity information;
in response to said triggering, presenting the selected question on the client device, by means of a question presentation module, in accordance with the activity performed; and
processing by means of a processor, a response received from the learner on the client device.

2. The method according to claim 1, further comprising building at least one of said questions and the associated answer to each question.

3. The method according to claim 2, wherein the building comprises building the question according to a structured format.

4. The method according to claim 3, wherein the structure format of the question and answer is a Script Concordance Test (SCT) format.

5. The method according to claim 2, wherein the building comprises processing input information from a plurality of experts, via a user interface, in order to build the question collaboratively.

6. The method according to claim 2, wherein the building comprises prompting a user to enter input information and processing the input information according to a predetermined process, to generate the question.

7. The method according to claim 2, wherein the building comprises:
providing, in a storage, a question template comprising one or more base question-element and one or more variable question-element, each variable question-element being associated to a plurality of possible values; and
generating, by means of a processor, a list of question instances, each instance comprising a unique combination of one of said possible value for each variable question-element within the question template.

8. The method according to claim 7, wherein the question instances generated are submitted to a user for review.

9. The method according to claim 1, wherein the triggering occurs based on a time information.

10. The method according to claim 9, wherein the time information comprises a date and time, and wherein the triggering occurs at said date and time.

11. The method according to claim 10, wherein the time information comprises a recurrence setting in order to recurrently present a new one of said questions.

12. The method according to claim 11, wherein the recurrence setting comprises limiting conditions.

13. The method according to claim 1, wherein the presenting and processing steps are sequentially repeated upon said triggering, in order to process a set among the stored questions.

14. The method according to claim 13, wherein the sequential repeating is limited within a time period.

15. The method according to claim 1, wherein the triggering occurs based on location information associated to the learner.

16. The method according to claim 15, further comprising providing a reference location in a memory; and wherein the triggering comprises:
receiving the location information in a processor;
comparing, by means of the processor, the location information received with the reference location; and
upon identifying a match between the location information and the reference location, triggering the question presentation module to present the question.

17. The method according to claim 16, wherein the location information is received by means of at least one among: a geo-location sensor; a proximity sensor; and
information entered in an electronic filing system.

18. The method according to claim 1, wherein the triggering further comprises: prior to triggering, waiting for a given time delay.

19. The method according to claim 15, further comprising:
providing knowledge categories of the professional practice
wherein each of the questions is associated to a given one of the knowledge categories and the location information is associated to one of the knowledge categories; and
wherein the presenting step comprises selecting the question to be presented, to correspond to the knowledge category of the location information.

20. The method according to claim 1, wherein each of the questions is associated to a knowledge category, and wherein the presenting step comprises:
receiving a knowledge category; and
selecting the question to correspond to the knowledge category.

21. The method according to claim 20, wherein the knowledge category is received based on at least one of: a location information of the learner time information; information entered in an electronic filing system being indicative of activity in a particular area of practice; and profile information associated to the learner.

22-25. (canceled)

26. A processor-readable non-transitory storage medium for learning, the processor-readable storage comprising data and instructions for execution by a processor, to execute the steps of the method, in accordance with claim 1.

27. (canceled)

28. A system for learning, directed to a learner of a professional practice, comprising:
a storage for storing questions and associated answers, relative to the professional practice;
an input port for receiving professional activity information being representative of an activity performed by the learner in the context of the professional practice;
a triggering device comprising said input port, for triggering a client device to present a selected one of said questions to the learner based on the professional activity information;
a question presentation module being in communication with the storage and the triggering device, for presenting the question on the client device, in response to said triggering according to the activity performed; and
a processor for processing a response received from the learner through the client device.

29-30. (canceled)

31. A system according to claim 28, wherein the triggering device communicates with at least one of: a position sensor, a geo-location sensor, a proximity sensor, an electronic filing system.

32. A system according to claim 28, wherein the processor is provided on a server being in communication with said client device over a communication network.
